(19) United States
(12) Patent Application Publication
(10) Pub. No.: US 2026/0195513 A1
(43) Pub. Date: Jul. 9, 2026

(54) INFORMATION PROCESSING DEVICE, INFORMATION PROCESSING METHOD, AND INFORMATION PROCESSING PROGRAM

(71) Applicant: Yazaki Corporation, Tokyo (JP)

(72) Inventors: Kazutaka UKI, Kakegawa-shi (JP); Takashi SAKABE, Susono-shi (JP)

(73) Assignee: Yazaki Corporation, Tokyo (JP)

(21) Appl. No.: 19/556,313

(22) Filed: Mar. 4, 2026

Related U.S. Application Data
(63) Continuation of application No. PCT/JP2024/038995, filed on Nov. 1, 2024.

(30) Foreign Application Priority Data
Dec. 6, 2023 (JP) 2023-205794

(51) Int. Cl. G06F 30/33; G06F 119/08

(52) U.S. Cl. CPC G06F 30/33; G06F 2119/08

(57) ABSTRACT

An objective of the present invention is to analyze a temperature distribution of a circuit including an electronic component. In order to achieve the objective, a thermal equivalent circuit for each of elements of a series circuit is modelled as a device that includes one or more terminals to be connected to one or more thermal equivalent circuits for one or more other of the elements of the series circuit, and connection of thermal equivalent circuits modelled according to the first modelling step is performed via the one or more terminals in order to model a thermal equivalent circuit for the series circuit, wherein the connection is performed.

### BACKGROUND OF THE INVENTION

### Cross Reference to Related Applications

This application is a Rule 53(b) Continuation of International Application No. PCT/JP2024/038995 filed Nov. 1, 2024, claiming priority based on Japanese Patent Application No. 2023-205794 filed Dec. 6, 2023, the disclosures of which are incorporated herein by reference in their entireties.

### TECHNICAL FIELD

The present invention relates to an information processing system, an information processing method and an information processing program.

### BACKGROUND ART

In recent years, electronization of vehicles has been enhanced. Accordingly, an amount of heat is increased which is generated by electronic components and/or wire harnesses installed in a vehicle, which necessitates design based on thermal analysis (e.g. Non-Patent Document 1). For example, a method of analyzing a temperature distribution of a wire harness is disclosed in Patent Document 1.

### CITATION LIST

### Patent Literature

Patent Document 1: JP 2018-128426 A

### Non-Patent Literature

Non-Patent Document 1: Keiji Mashimo et al. “Heat Transfer Analysis for Vehicle Electronic Parts”, [online], July 2002, Furukawa Electric Review No. 110, [searched in internet on Sep. 28, 2023], https://www.furukawa.co.jp/jiho/fj110/fj110_16.pdf.

### SUMMARY OF THE INVENTION

Patent Document 1 does not disclose a method of analyzing a temperature distribution of a circuit including an electronic component such as a fuse or contactor.

Therefore, an objective of the present invention is to analyze a temperature distribution of a circuit including an electronic component.

In order to achieve the above objective, an information processing system according to an embodiment of the present invention is provided for analyzing a temperature distribution of a series circuit including an electronic component, the information processing system comprising: a first modelling section configured to model a thermal equivalent circuit for each of elements of a series circuit as a device that includes one or more terminals to be connected to one or more thermal equivalent circuits for one or more other of the elements of the series circuit; and a second modelling section configured to perform connection of thermal equivalent circuits modelled by the first modelling section in order to model a thermal equivalent circuit for the series circuit, wherein the connection is performed through the one or more terminals.

An information processing method according to an embodiment of the present invention is implemented by a computer for analyzing a temperature distribution of a series circuit including an electronic component, the information processing method comprising: a first modelling step of modelling a thermal equivalent circuit for each of elements of a series circuit as a device that includes one or more terminals to be connected to one or more thermal equivalent circuits for one or more other of the elements of the series circuit; and a second modelling step of performing connection of thermal equivalent circuits modelled according to the first modelling step in order to model a thermal equivalent circuit for the series circuit, wherein the connection is performed via the one or more terminals.

An information processing program according to an embodiment of the present invention is configured to cause a computer to perform the above analysis method.

The present invention enables a temperature distribution of a circuit including an electronic component to be analyzed.

### BRIEF DESCRIPTION OF THE DRAWINGS

FIG. 1 shows an analysis device 100 according to an embodiment of the present invention;

FIG. 2 shows an example of a series circuit SC;

FIG. 3 shows a control section 110;

FIG. 4 shows exemplary processing operations in the control section 110;

FIG. 5 shows an example of a basic thermal equivalent circuit of busbars which are not accommodated in a circuit case CC;

FIG. 6 shows an example of a basic thermal equivalent circuit of busbars which are accommodated in a circuit case CC;

FIG. 7 shows an example of a basic thermal equivalent circuit of busbars which are not accommodated in a circuit case CC;

FIG. 8 shows an example of a thermal equivalent circuit of busbars which are not accommodated in a circuit case CC;

FIG. 9 shows an example of a thermal equivalent circuit of busbars which are accommodated in a circuit case CC;

FIG. 10 shows an example of a basic thermal equivalent circuit of electric wires which are not accommodated in a circuit case CC;

FIG. 11 shows an example of a basic thermal equivalent circuit of electric wires which are accommodated in a circuit case CC;

FIG. 12 shows an example of a thermal equivalent circuit of electric wires which are not accommodated in a circuit case CC;

FIG. 13 shows an example of a thermal equivalent circuit of electric wires which are accommodated in a circuit case CC;

FIG. 14 shows an example of a thermal equivalent circuit of a fuse which is not accommodated in a circuit case CC;

FIG. 15 shows an example of a thermal equivalent circuit of the fuse which is accommodated in a circuit case CC;

FIG. 16 shows an example of a thermal equivalent circuit of the fuse which is not accommodated in a circuit case CC;

FIG. 17 shows an example of a thermal equivalent circuit of a contactor which is not accommodated in a circuit case CC;

FIG. 18 shows an example of a thermal equivalent circuit of the contactor which is accommodated in a circuit case CC;

FIG. 19 shows an example of a thermal equivalent circuit of a series circuit SC which is configured as the exemplary series circuit SC as shown in FIG. 2;

FIG. 20 shows an example of a basic thermal equivalent circuit of busbars which are not accommodated in a circuit case CC but are cooled;

FIG. 21 shows an example of a basic thermal equivalent circuit of busbars which are accommodated in a circuit case CC and cooled;

FIG. 22 shows an example of a thermal equivalent circuit of a series circuit SC which is configured as the exemplary series circuit SC as shown in FIG. 2; and

FIG. 23 shows an example of a thermal equivalent circuit of a series circuit SC which is configured as the exemplary series circuit SC as shown in FIG. 22 with a changed order of cooling.

### DETAILED DESCRIPTION OF THE PREFERRED EMBODIMENTS

### <Analysis Device 100>

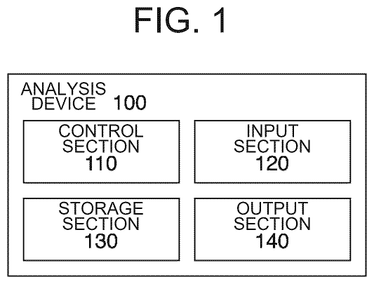

FIG. 1 shows an analysis device 100 according to an embodiment of the present invention. The analysis device 100 includes a control section 110, an input section 120, a storage section 130, and an output section 140.

The control section 110 is an information processing system, such as a computer, configured to process information. The input section 120 is an input device, such as a keyboard, touch panel, camera and/or a microphone, configured to receive information as an input. The storage section 130 is a storage device, such as a hard disk drive, solid state drive and/or a memory, configured to store information. The output section 140 is an output device configured to output information, for example a display device for displaying information, such as a display, a printing device for providing printed information, such as a printer, and/or an audio output device for providing an audio output related to information, such as a speaker.

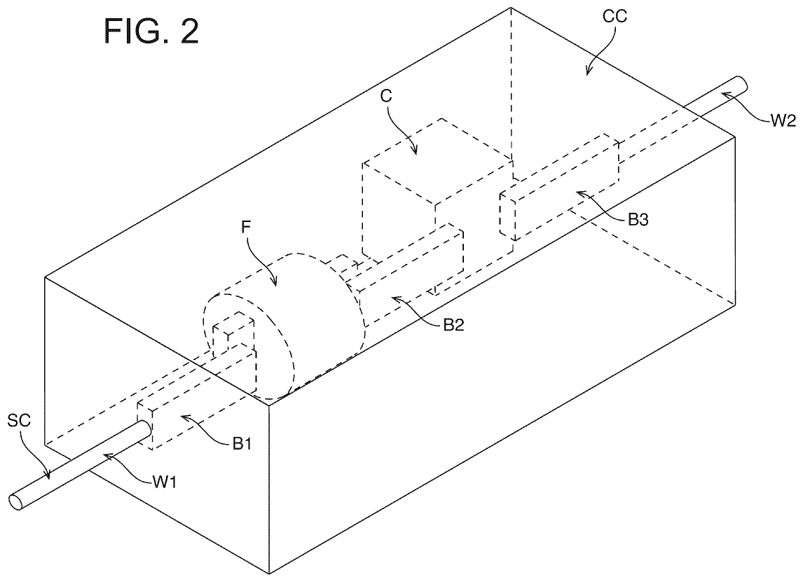

The analysis device 100 is provided for analyzing a temperature distribution of a series circuit SC, wherein the series circuit SC includes one or more electronic components, one or more electric wires, and one or more busbars which are connected in series. For example, the one or more electronic components include a contactor and/or a fuse, as shown in FIG. 2. In the example shown in FIG. 2, electric wires W1 and W2, busbars B1-B3, a fuse F and a contactor C are connected in series, wherein the electric wire W1, the busbar B1, the fuse F, the busbar B2, the contactor C, the busbar B3, and the electric wire W2 are connected in series in this order. In the example shown in FIG. 2, the busbars B1-B3, fuse F and contactor C of the series circuit SC are accommodated in a case (circuit case CC). For example, the circuit case CC is a junction box.

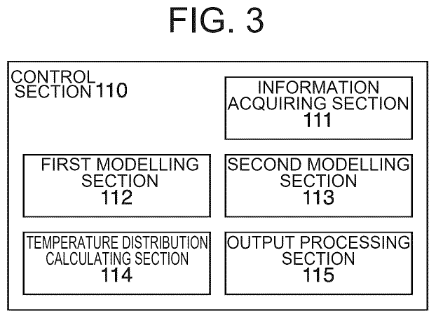

FIG. 3 shows a control section 110. The control section 110 includes an information acquiring section 111, a first modelling section 112, a second modelling section 113, a temperature distribution calculating section 114, and an output processing section 115.

The information acquiring section 111 is configured to acquire information about the series circuit SC which has been received by the input section 120. When the storage section 130 includes information about the series circuit SC stored therein, the information acquiring section 111 is configured to acquire the information about the series circuit SC from the storage section 130. The information about the series circuit SC includes interconnection between elements of the series circuit SC, a relation between the series circuit SC and the circuit case CC, parameters of the individual elements of the series circuit SC.

For analyzing a temperature distribution of the series circuit SC according to FIG. 2, the information acquiring section 111 acquires, as the interconnection between the elements, information indicating that the electric wires W1 and W2, the busbars B1-B3, the fuse F, and the contactor C are connected in series in the order of busbar B1, fuse F, busbar B2, contactor C, busbar B3, and then electric wire W2. As the relation between the series circuit SC and the circuit case CC, the information acquiring section 111 further acquires information indicating that the electric wires W1 and W2 of the series circuit SC are not accommodated in the circuit case CC while the busbars B1-B3, fuse F and contactor C are accommodated in the circuit case CC. As the parameters of the individual elements of the series circuit SC, the information acquiring section 111 acquires individual parameters of the electric wires W1 and W2, busbars B1-B3, fuse F and contactor C.

Based on the information about the series circuit SC acquired by the information acquiring section 111, the first modelling section 112 models a thermal equivalent circuit for each of the elements of the series circuit SC as a device that includes one or more terminals to be connected to one or more thermal equivalent circuits for one or more other of the elements of the series circuit SC. Especially, when at least part of the series circuit SC is accommodated in the circuit case CC, the first modelling section 112 is configured to model the thermal equivalent circuit for each of the elements of the series circuit SC as a device that includes the one or more terminals to be connected to the one or more thermal equivalent circuits for the one or more other of the elements of the series circuit SC as well as a terminal to be connected to a thermal equivalent circuit for external air or a thermal equivalent circuit for the circuit case CC, and model the thermal equivalent circuit for the circuit case CC as a device that includes a terminal to be connected to a thermal equivalent circuit for each of one or more of the elements of the series circuit accommodated in the circuit case CC as well as a terminal to be connected to the thermal equivalent circuit for the external air.

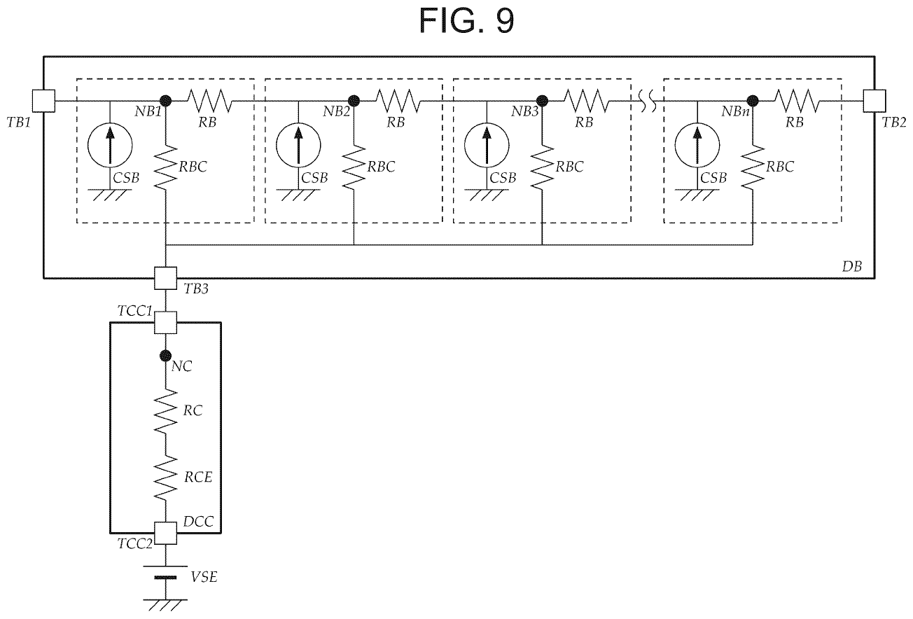

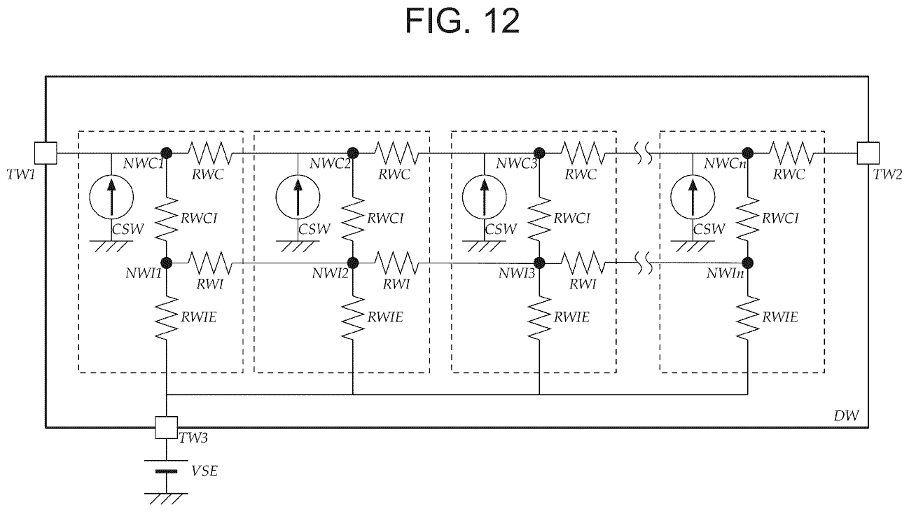

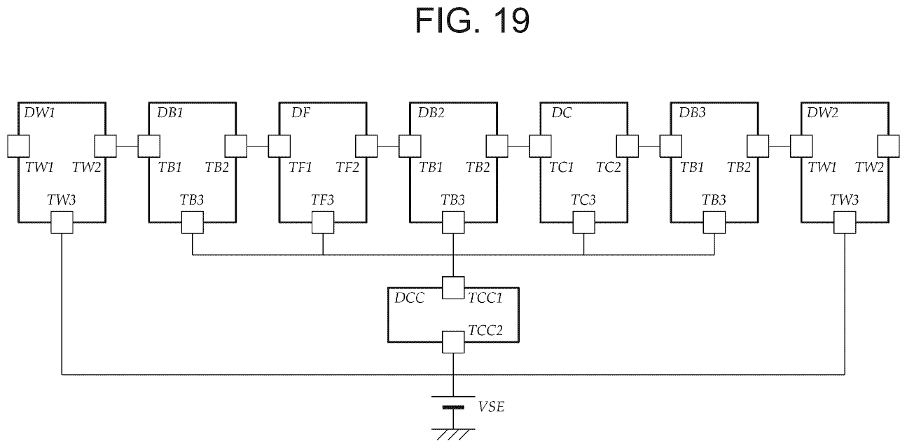

For analyzing the temperature distribution of the series circuit according to FIG. 2, for example, the first modelling section 112 models each of the electric wires W1 and W2 as a device DW that includes terminals TW1 and TW2 to be connected to other elements as well as a terminal TW3 to be connected to a thermal equivalent circuit VSE for the external air as shown in FIGS. 12 and 19, wherein the electric wires W1 and W2 are not accommodated in the circuit case CC. The first modelling section 112 further models a thermal equivalent circuit for each of the busbars B1-B3, fuse F, and contactor C as a device DB, DF, DC that includes terminals TB1, TB2, TF1, TF2, TC1, TC2 to be connected to other elements as well as a terminal TB3, TF3, TC3 to be connected to a device DCC as shown in FIGS. 9, 15, 18 and 19, the device DCC modelling a thermal equivalent circuit for the circuit case CC, wherein the busbars B1-B3, fuse F, and contactor C are accommodated in the circuit case CC. In addition, the first modelling section 112 models the circuit case CC as the device DCC that includes a terminal TCC1 and a terminal TCC2 as shown in FIGS. 9, 15, 18 and 19, wherein the terminal TCC1 is configured to be connected to the devices DB, DF, and DC modelling the thermal equivalent circuits for the elements accommodated in the circuit case CC, i.e. the busbars B1-B3, fuse F, and contactor C, and the terminal TCC2 is configured to be connected to the thermal equivalent circuit VSE for the external air.

Based on the information about the series circuit SC acquired by the information acquiring section 111, the second modelling section 113 is configured to perform connection of the thermal equivalent circuits modelled by the first modelling section 112 in order to model a thermal equivalent circuit for the series circuit SC, wherein the connection is performed through the terminals.

For analyzing a temperature distribution of the series circuit according to FIG. 2, the second modelling section 113 is configured to perform connection of the thermal equivalent circuits DW, DB, DF, DC and DCC modelled by the first modelling section 112 in order to model the thermal equivalent circuit for the series circuit SC as shown in FIG. 19, wherein the connection is performed through the terminals TW1-TW3, TB1-TB3, TC1-TC3, TCC1 and TCC2.

The temperature distribution calculating section 114 is configured to calculate the temperature distribution of the series circuit SC based on the thermal equivalent circuit of the series circuit SC modelled by the second modelling section 113. For calculating the temperature distribution of the series circuit SC, for example, the temperature distribution calculating section 114 uses Kirchhoff's law to determine a relation between a temperature of each node and a temperature of a node adjacent to the node of the thermal equivalent circuit for the series circuit SC modelled by the second modelling section 113. The temperature distribution calculating section 114 then solves the relation in the form of simultaneous equations to calculate the temperature of each node on the series circuit SC for calculating the temperature distribution of the series circuit SC.

The relation between the temperature of each node and the temperature of the adjacent node may be determined by using Kirchhoff's law, provided that values for thermal resistances included in the thermal equivalent circuit, a value for a heat flow provided by a current source, and a value for a temperature of a voltage source are known. Therefore, the information acquiring section 111 may be preferably configured to acquire values for thermal resistances included in the thermal equivalent circuits for the elements, a value for the heat flow provided by the current source, and the temperature of the voltage source (e.g. temperature of the external air) as parameters of the individual elements of the series circuit SC. Furthermore, the values for the thermal resistances included in the thermal equivalent circuits for the elements and/or the value for the heat flow provided by the current source may be calculated by means of one or more parameters such as a size (length and/or cross-section area) of each element, a value for a current flowing through each element, a resistance value of each element, and/or a thermal conductivity of each element. Therefore, the information acquiring section 111 may be configured to acquire, as the parameters of the individual elements of the series circuit SC, one or more parameters used for calculating the values for the thermal resistances included in the thermal equivalent circuits for the elements and/or the value for the heat flow provided by the current source (for example a size (e.g. length and/or cross-section area) of each element, a value for a current flowing through each element, a resistance value of each element, and/or a thermal conductivity of each element).

The output processing section 115 is configured to provide the temperature distribution of the series circuit SC calculated by the temperature distribution calculating section 114. The output processing section 115 provides the temperature distribution of the series circuit SC by displaying a one-dimensional temperature distribution on a display device and/or printing a one-dimensional temperature distribution by means of a printing device.

In this manner, the present embodiment enables a temperature distribution of a circuit including one or more electronic components to be analyzed. According to the present embodiment, the temperature distribution of the series circuit SC is calculated by solving the simultaneous equations. Therefore, the present embodiment enables the temperature distribution calculating section 114 to be implemented by using a common spreadsheet software.

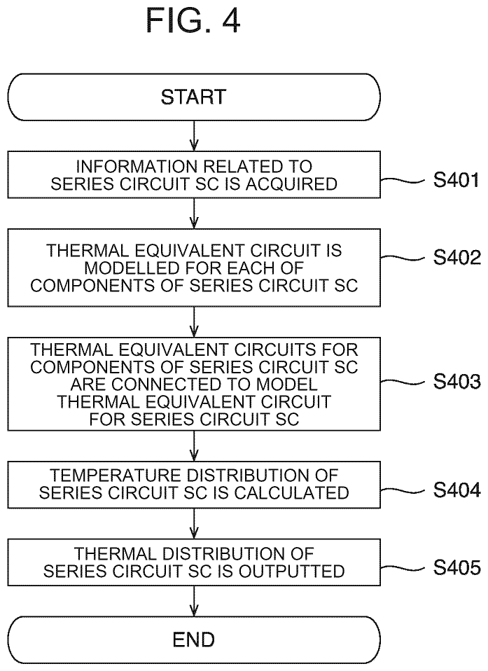

FIG. 4 shows exemplary processing operations in the control section 110. The information acquiring section 111 acquires information about the series circuit SC (step S401). Based on the information about the series circuit SC, the first modelling section 112 models a thermal equivalent circuit for each of the elements of the series circuit SC as a device that includes one or more terminals to be connected to one or more thermal equivalent circuits for one or more other of the elements of the series circuit SC (step S402). Based on the information about the series circuit SC, the second modelling section 113 is configured to perform connection of the thermal equivalent circuits modelled by the first modelling section 112 in order to model a thermal equivalent circuit for the series circuit SC, wherein the connection is performed through the terminals (step S403). The temperature distribution calculating section 114 is configured to calculate the temperature distribution of the series circuit SC based on the thermal equivalent circuit of the series circuit SC modelled by the second modelling section 113 (step S404). The output processing section 115 is configured to provide the temperature distribution of the series circuit SC calculated by the temperature distribution calculating section 114 (step S405).

### <First Modelling Section 112>

In a case where the series circuit SC includes one or more busbars and/or electric wires and/or the series circuit SC includes one or more fuses and/or contactors as the one or more electronic components, the first modelling section 112 models a thermal equivalent circuit for each of the one or more busbars, electric wires, fuses and/or contactors—which are elements of the series circuit SC—as a device that includes one or more terminals to be connected to one or more thermal equivalent circuits for one or more other elements of the series circuit SC.

### (Modelling Process of Thermal Equivalent Circuits of the Busbars)

In a case where the series circuit SC includes one or more busbars, the first modelling section 112 divides a busbar with a first length first (for example 1 cm) per divided busbar portion of the busbar and then models basic thermal equivalent circuits for the busbar, each of the basic thermal equivalent circuits corresponding to a thermal equivalent circuit for one of the divided busbar portion of the busbar with the first length.

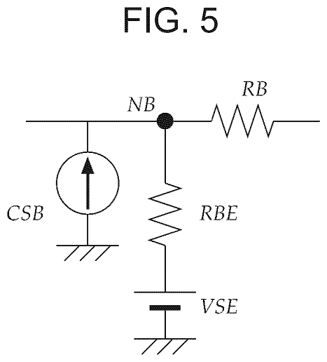

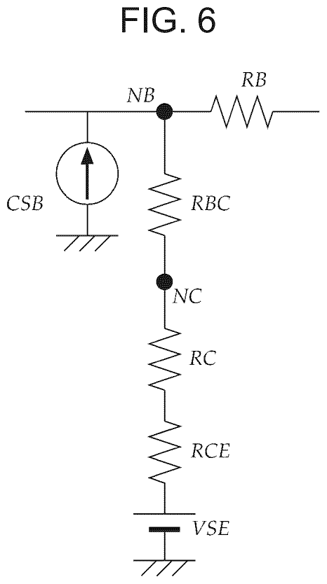

FIGS. 5 and 6 show exemplary basic thermal equivalent circuits of busbars modelled by the first modelling section 112. FIG. 5 shows a basic thermal equivalent circuit of busbars which are not accommodated in a circuit case CC, while FIG. 6 shows a basic thermal equivalent circuit of busbars which are accommodated in a circuit case CC.

In FIGS. 5 and 6, a node NB corresponds to the busbar. In FIG. 5, a node NC corresponds to the circuit case CC.

In FIGS. 5 and 6, a current source CSB models a Joule heat generated by the busbar, and a voltage source VSE models the thermal equivalent circuit for the external air. A heat flow provided by the current source CSB is a Joule heat generated by a busbar portion with the first length. This heat flow is calculated by means of the value for the current flowing through the series circuit SC and the resistance value of the busbar portion with the first length. The temperature of the voltage source VSE is a temperature of the external air.

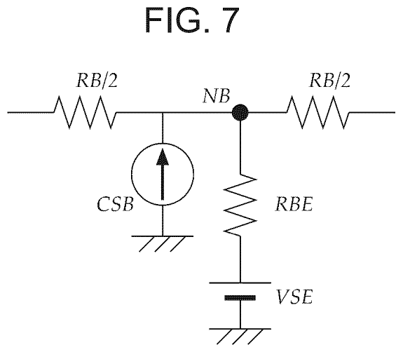

In FIGS. 5 and 6, a thermal resistance RB is a thermal resistance in heat transfer of the busbar in a longitudinal direction (direction in which the busbar extends). For example, the thermal resistance RB is calculated according to the following formula:

$$R B = \frac{L B P}{λ B \cdot SB} , \qquad ( 1 )$$

wherein LBP indicates the first length, λB indicates a thermal conductivity of the busbar, SB indicates a cross-section area of the busbar along a plane perpendicular to the longitudinal direction of the busbar. While the node NB in FIGS. 5 and 6 corresponds to an end of a busbar portion with the first length, the node NB may correspond to a middle portion of a busbar portion with the first length in the longitudinal direction. In this case, the thermal resistance in the heat transfer of the busbar in the longitudinal direction is positioned on each of opposite sides of the node NB with a thermal resistance value of RB/2, as shown in FIG. 7. FIG. 7 shows a basic thermal equivalent circuit of busbars in a case where the series circuit SC is not accommodated in a circuit case CC.

In FIG. 5, a thermal resistance RBE is a thermal resistance in heat transfer from the busbar to the external air (air outside the busbar). The thermal resistance RBE is a resulting thermal resistance of a convection heat transfer resistance RBE1 and a radiation heat transfer resistance RBE2, wherein the convection heat transfer resistance RBE1 and the radiation heat transfer resistance RBE2 are applied from the busbar to the external air. The thermal resistance RBE, i.e. the resulting thermal resistance, is calculated from the convection heat transfer resistance RBE1 and radiation heat transfer resistance RBE2 as follows:

$$\frac{1}{R B E} = \frac{1}{R B E 1} + \frac{1}{R B E 2} \qquad ( 2 )$$

For example, the convection heat transfer resistance RBE1 and the radiation heat transfer resistance RBE2 are calculated by means of thermofluid analysis as follows:

$$\{ \begin{matrix}RBE 1 = \frac{1}{S A B} \cdot \frac{1}{2 \text{.51} \cdot KB} \cdot {( \frac{T S B - T E}{L R B} )}^{- 0.25} \\ R B E 2 = \frac{1}{σ \cdot SAB \cdot FC \cdot f} \cdot {( \frac{T S B + T E}{2} )}^{- 3}\end{matrix} , \qquad ( 3 )$$

wherein SAB indicates a surface area of a busbar portion with the first length, KB indicates a coefficient determined by a shape and an installation condition of the busbar portion with the first length, LRB indicates a representative length determined by the shape and the installation condition of the busbar portion with the first length, TSB indicates a surface temperature of the busbar, TE indicates the temperature of the external air, σ indicates the Stefan-Boltzmann constant, FC indicates a view factor, and f indicates an emissivity.

In FIG. 6, a thermal resistance RBC is a thermal resistance in heat transfer from the busbar to the circuit case CC through internal air (air inside the circuit case CC). The thermal resistance RBC is a resulting thermal resistance of a convection heat transfer resistance RBC1 and a radiation heat transfer resistance RBC2, wherein the convection heat transfer resistance RBC1 and the radiation heat transfer resistance RBC2 are applied from the busbar to the circuit case CC through the internal air. The thermal resistance RBC, i.e. the resulting thermal resistance, is calculated from the convection heat transfer resistance RBC1 and radiation heat transfer resistance RBC2 as follows:

$$\frac{1}{R B C} = \frac{1}{R B C 1} + \frac{1}{R B C 2} \qquad ( 4 )$$

The convection heat transfer resistance RBC1 and the radiation heat transfer resistance RBC2 are calculated by means of thermofluid analysis.

In FIG. 6, a thermal resistance RC is a thermal resistance of the circuit case CC. For example, the thermal resistance RC is calculated according to the following formula:

$$R C = \frac{L C}{λC \cdot SC} \qquad ( 5 )$$

wherein LC indicates a length of the circuit case CC in a longitudinal direction, XC indicates a thermal conductivity of the circuit case CC, SC indicates a cross-section area of the circuit case CC along a plane perpendicular to the longitudinal direction.

In FIG. 6, a thermal resistance RCE is a thermal resistance in heat transfer from the circuit case CC to the external air (air outside the circuit case CC). The thermal resistance RCE is a resulting thermal resistance of a convection heat transfer resistance RCE1 and a radiation heat transfer resistance RCE2, wherein the convection heat transfer resistance RCE1 is applied from the circuit case CC to the external air and the radiation heat transfer resistance RCE2 is applied from the electric wire to the external air. The thermal resistance RCE, i.e. the resulting thermal resistance, is calculated from the convection heat transfer resistance RCE1 and radiation heat transfer resistance RCE2 as follows:

$$\frac{1}{R C E} = \frac{1}{R C E 1} + \frac{1}{R C E 2} \qquad ( 6 )$$

The convection heat transfer resistance RCE1 and the radiation heat transfer resistance RCE2 are calculated by means of thermofluid analysis.

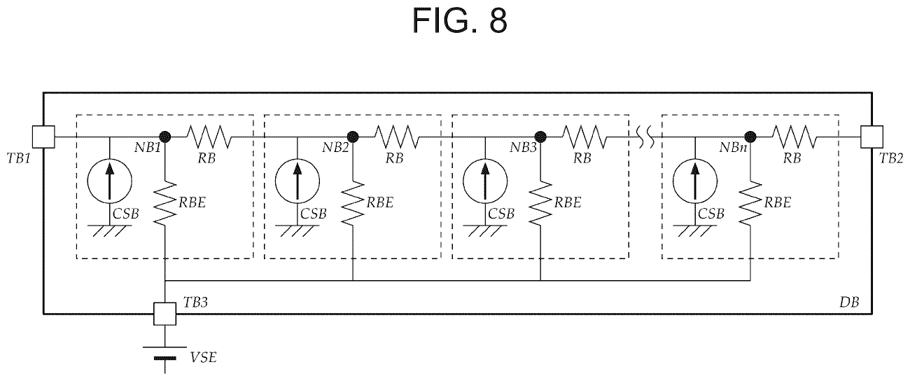

After modelling the basic thermal equivalent circuits of the busbar as described above, the first modelling section 112 connects the basic thermal equivalent circuits for the busbar to model a thermal equivalent circuit for the busbar as the device DB that includes the terminals TB1, TB2 and TB3 to be connected to the thermal equivalent circuits for the other elements of the series circuit SC. FIGS. 8 and 9 show exemplary thermal equivalent circuits of busbars modelled by the first modelling section 112. FIG. 8 shows a thermal equivalent circuit of busbars in a case where the series circuit SC is not accommodated in a circuit case CC, while FIG. 9 shows a thermal equivalent circuit of busbars in a case where the series circuit SC is accommodated in a circuit case CC. In a case where the series circuit SC is accommodated in the circuit case CC, the first modelling section 112 models the thermal equivalent circuit for the circuit case CC as the device DCC that includes the terminals TCC1 and TTC2.

In FIGS. 8 and 9, the terminals TB1 and TB2 of the device DB are terminals to be connected to devices modelling other elements of the series circuit SC. In FIGS. 8 and 9, the terminal TB3 of the device DB is a terminal to be connected to the voltage source VSE modelling the thermal equivalent circuit for the external air or to the device DCC modelling the thermal equivalent circuit for the case. In FIG. 8, the terminal TCC1 of the device DCC is a terminal to be connected to devices modelling elements of the elements of the series circuit SC which are accommodated in the circuit case CC, and the terminal TCC2 of the device DB is a terminal to be connected to the voltage source VSE modelling the thermal equivalent circuit for the external air.

In FIGS. 8 and 9, in a stationary state, the Kirchhoff's law is fulfilled between heat flows flowing into the node NB2, i.e., between a heat flow QB flowing into the node NB2 from the current source CSB (namely, Joule heat generated in a busbar portion with the first length), a heat flow QNB22 flowing into the node NB2 from the node NB1 through the thermal resistance RB, a heat flow QNB23 flowing into the node NB2 from the node NB3 through the thermal resistance RB, and a heat flow QNB24 flowing into the node NB2 from the voltage source VSE through the thermal resistance RBE or flowing into the node NB2 from the node NC through the thermal resistance RBC.

$$Q B + QNB 22 + QNB 23 + QNB 24 = 0 \qquad ( 7 )$$

In a case where the busbar is not accommodated in the circuit case CC, the following relation exists between a temperature T1 of the node NB1, a temperature T2 of the node NB2, a temperature T3 of the node NB3, and a temperature TE of the external air:

$$QB + \frac{T 1 - T 2}{RB} + \frac{T 3 - T 2}{RB} + \frac{T E - T 2}{RBE} = 0 \qquad ( 8 )$$

In a case where the busbar is accommodated in the circuit case CC, the following relation exists between the temperature T1 of the node NB1, the temperature T2 of the node NB2, the temperature T3 of the node NB3, and a temperature TC of the circuit case CC:

$$QB + \frac{T 1 - T 2}{RB} + \frac{T 3 - T 2}{RB} + \frac{TC - T2}{RBC} = 0 \qquad ( 9 )$$

For other nodes, a relation between a temperature of each of the other nodes and a temperature of a node of the other nodes adjacent to the node may be determined according to the Kirchhoff's law similarly.

### (Modelling Process of Thermal Equivalent Circuits for the Electric Wires)

In a case where the series circuit SC includes one or more electric wires, the first modelling section 112 divides an electric wire with a second length first (for example 1 cm) per divided electric wire portion of the electric wire and then models basic thermal equivalent circuits for the electric wire, each of the basic thermal equivalent circuits corresponding to a thermal equivalent circuit for one of the divided electric wire portion of the electric wire with the second length.

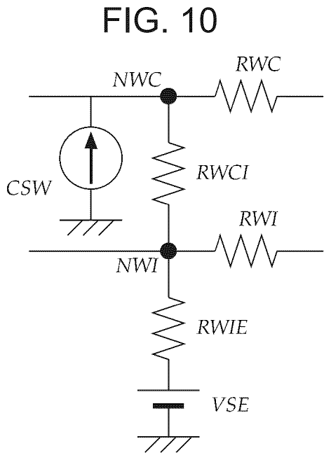

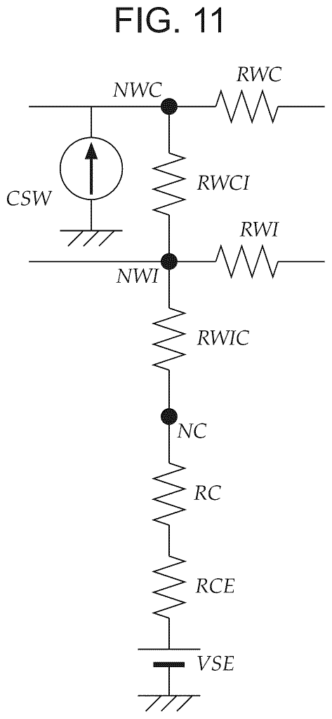

FIGS. 10 and 11 show exemplary basic thermal equivalent circuits of electric wires modelled by the first modelling section 112. FIG. 10 shows a basic thermal equivalent circuit of electric wires which are not accommodated in a circuit case CC, while FIG. 11 shows a basic thermal equivalent circuit of electric wires which are accommodated in a circuit case CC.

Each of the electric wires as shown in FIGS. 10 and 11 includes a conductor and an exterior material (e.g. an insulator) placed around the conductor and covering the conductor. In FIGS. 10 and 11, a node NWC corresponds to the conductor of the electric wire, and a node NWI corresponds to the exterior material of the conductor.

In FIGS. 10 and 11, a current source CSW models a heat generating source of the conductor of the electric wire.

In FIGS. 10 and 11, a thermal resistance RWC is a thermal resistance in heat transfer of the conductor of the electric wire in a longitudinal direction (direction in which the conductor extends), and a thermal resistance RWI is a thermal resistance in heat transfer of the exterior material of the electric wire in the longitudinal direction. For example, the thermal resistances RWC and RWI are calculated according to the following formulas:

$$\{ \begin{matrix}RWC = \frac{LWP}{λ WC \cdot SWC} \\ RWI = \frac{LWP}{λ WI \cdot SWI}\end{matrix} , \qquad ( 10 )$$

wherein LWP indicates the second length, λWC indicates a thermal conductivity of the conductor of the electric wire, SWC indicates a cross-section area of the conductor of the electric wire, λWI indicates a thermal conductivity of the exterior material of the electric wire, and SWI indicates a cross-section area of the exterior material of the electric wire. While the node NWC (NWI) in FIGS. 10 and 11 corresponds to an end of a conductor portion (exterior material portion) with the second length, the node NWC (NWI) may correspond to a middle portion of a conductor portion (exterior material portion) with the second length in the longitudinal direction. In this case, the thermal resistance in the heat transfer of the conductor (exterior material) in the longitudinal direction is positioned on each of opposite sides of the node NWC (NWI) with a thermal resistance value of RWC/2 (RWI/2).

In FIGS. 10 and 11, a thermal resistance RWCI is a thermal resistance in heat transfer from the conductor of the electric wire to the exterior material. The thermal resistance RWCI is calculated by means of thermofluid analysis.

In FIG. 10, a thermal resistance RWIE is a thermal resistance in heat transfer from the exterior material of the electric wire to the external air (air outside the electric wire). The thermal resistance RWIE is a resulting thermal resistance of a convection heat transfer resistance RWIE1 and a radiation heat transfer resistance RWIE2, wherein the convection heat transfer resistance RWIE1 and the radiation heat transfer resistance RWIE2 are applied from the exterior material of the electric wire to the external air. The thermal resistance RWIE, i.e. the resulting thermal resistance, is calculated from the convection heat transfer resistance RWIE1 and radiation heat transfer resistance RWIE2 as follows:

$$\frac{1}{RWIE} = \frac{1}{RWIE 1} + \frac{1}{RWIE 2} \qquad ( 11 )$$

The convection heat transfer resistance RWIE1 and the radiation heat transfer resistance RWIE2 are calculated by means of thermofluid analysis.

In FIG. 11, a thermal resistance RWIC is a thermal resistance in heat transfer from the exterior material of the electric wire to the circuit case CC through internal air (air inside the circuit case CC). The thermal resistance RWIC is a resulting thermal resistance of a convection heat transfer resistance RWIC1 and a radiation heat transfer resistance RWIC2, wherein the convection heat transfer resistance RWIC1 and the radiation heat transfer resistance RWIC2 are applied from the exterior material of the electric wire to the circuit case CC through the internal air. The thermal resistance RWIC, i.e. the resulting thermal resistance, is calculated from the convection heat transfer resistance RWIC1 and radiation heat transfer resistance RWIC2 as follows:

$$\frac{1}{RWIC} = \frac{1}{RWIC 1} + \frac{1}{RWIC 2} \qquad ( 12 )$$

The convection heat transfer resistance RWIC1 and the radiation heat transfer resistance RWIC2 are calculated by means of thermofluid analysis.

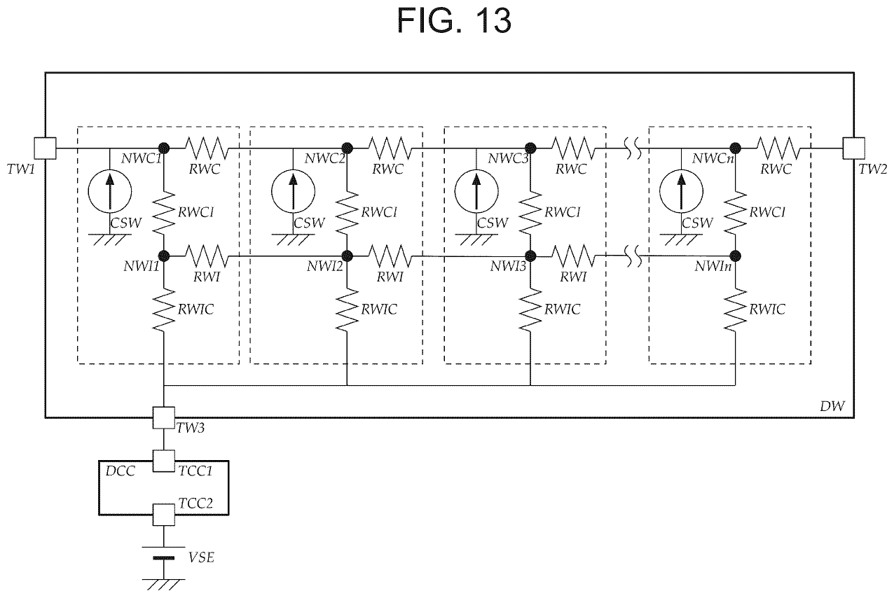

After modelling the basic thermal equivalent circuits of the electric wire as described above, the first modelling section 112 connects the basic thermal equivalent circuits for the electric wire to model a thermal equivalent circuit for the electric wire as the device DW that includes the terminals TW1, TW2 and TW3 to be connected to the thermal equivalent circuits for the other elements of the series circuit SC. FIGS. 12 and 13 show exemplary thermal equivalent circuits of electric wires modelled by the first modelling section 112. FIG. 12 shows a thermal equivalent circuit of electric wires in a case where the series circuit SC is not accommodated in a circuit case CC, while FIG. 13 shows a thermal equivalent circuit of electric wires in a case where the series circuit SC is accommodated in a circuit case CC.

In FIGS. 12 and 13, the terminals TW1 and TW2 of the device DW are terminals to be connected to devices modelling other elements of the series circuit SC. In FIGS. 12 and 13, the terminal TW3 of the device DW is a terminal to be connected to the voltage source VSE modelling the thermal equivalent circuit for the external air or to the device DCC modelling the thermal equivalent circuit for the circuit case CC.

For the nodes of the thermal equivalent circuits for the electric wires, a relation between a temperature of each of the nodes and a temperature of a node of the nodes adjacent to the node may be determined according to the Kirchhoff's law similarly.

### (Modelling Process of a Thermal Equivalent Circuit for the Fuse)

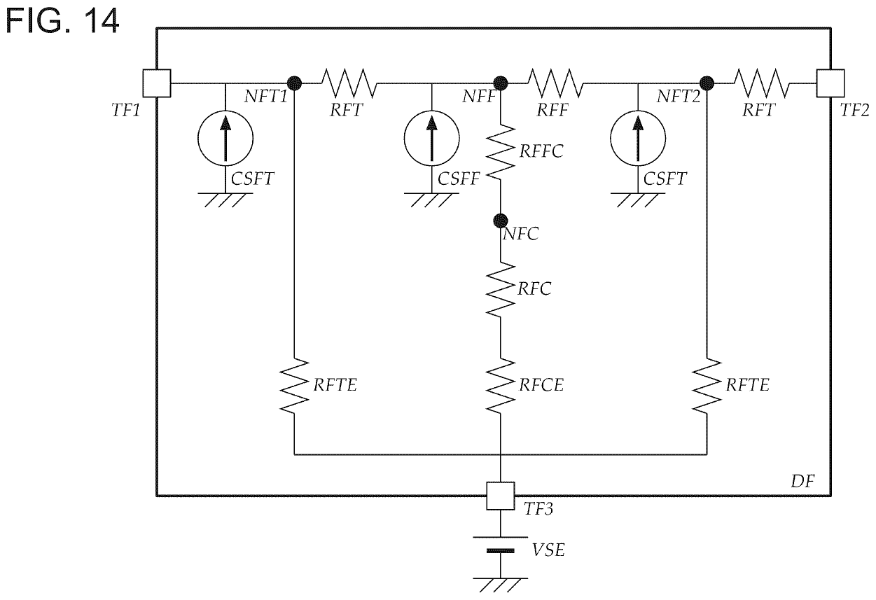

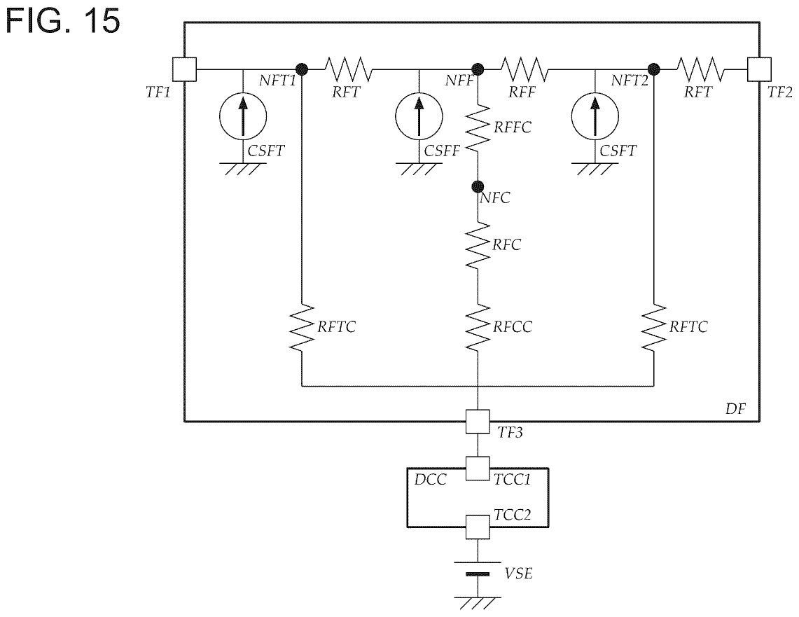

In a case where the series circuit SC includes a fuse as an electronic component, the first modelling section 112 models a thermal equivalent circuit for the fuse as a device DF that includes one or more terminals to be connected to one or more thermal equivalent circuits for one or more other of the elements of the series circuit SC. FIGS. 14 and 15 show exemplary thermal equivalent circuits of a fuse modelled by the first modelling section 112. FIG. 14 shows a thermal equivalent circuit of the fuse in a case where the series circuit SC is not accommodated in a circuit case CC, while FIG. 15 shows a thermal equivalent circuit of the fuse in a case where the series circuit SC is accommodated in a circuit case CC.

The fuse as shown in FIGS. 14 and 15 includes a melted portion, terminal portions provided at opposite ends of the melted portion, and a case (fuse case) covering the melted portion. In FIGS. 14 and 15, nodes NFT1 and NFT2 correspond to the opposite terminal portions, a node NFF corresponds to the melted portion, and a node NFC corresponds to the fuse case.

In FIGS. 14 and 15, a current source CSFF models a Joule heat generated in the melted portion, and current sources CSFT model Joule heats generated in the respective opposite terminal portions.

In FIGS. 14 and 15, thermal resistances RFT are thermal resistances in heat transfers of the terminal portions in a longitudinal direction (direction in which the melted portion extends), and a thermal resistance RFF is a thermal resistance in heat transfer of the melted portion in the longitudinal direction. The thermal resistances RFT and RFF are calculated according to the following formulas:

$$\{ \begin{matrix}RFT = \frac{LFT}{λ FT \cdot SFT} \\ RFF = \frac{LFF}{λ FF \cdot SFF}\end{matrix} , \qquad ( 13 )$$

wherein LFT indicates a length of the terminal portion in the longitudinal direction, UFT indicates a thermal conductivity of the terminal portion, SFT indicates a cross-section area of the terminal portion along a plane perpendicular to the longitudinal direction, LFF indicates a length of the melted portion in the longitudinal direction, XFF indicates a thermal conductivity of the melted portion, and SFF indicates a cross-section area of the melted portion along a plane perpendicular to the longitudinal direction. While the node NFT (NFF) in FIGS. 14 and 15 corresponds to an end of the terminal portion (melted portion), the node NFT (NFF) may correspond to a middle portion of the terminal portion (melted portion) in the longitudinal direction. In this case, the thermal resistance in the heat transfer of the terminal portion (melted portion) in the longitudinal direction is positioned on each of opposite sides of the node NFT (NFF) with a thermal resistance value of RFT/2 (RFF/2).

In FIGS. 14 and 15, a thermal resistance RFFC is a thermal resistance in heat transfer from the melted portion to the fuse case. The thermal resistance RFFC is calculated by means of thermofluid analysis.

In FIGS. 14 and 15, a thermal resistance RFC is a thermal resistance in heat transfer from the inside to the outside of the fuse case. For example, the thermal resistance RFC is calculated according to the following formula:

$$RFC = \frac{LFC}{λ FC \cdot SFC} , \qquad ( 14 )$$

wherein LFC indicates a length of the fuse case in a longitudinal direction, UFC indicates a thermal conductivity of the fuse case, SFC indicates a cross-section area of the fuse case along a plane perpendicular to the longitudinal direction.

In FIG. 14, a thermal resistance RFCE is a thermal resistance in heat transfer from the fuse case to the external air (air outside the fuse case), and a thermal resistance RFTE is a thermal resistance in heat transfer from the terminal portion to the external air. The thermal resistance RFCE is aresulting thermal resistance of a convection heat transfer resistance RFCE1 and a radiation heat transfer resistance RFCE2, wherein the convection heat transfer resistance RFCE1 and the radiation heat transfer resistance RFCE2 are applied from the fuse case to the external air. The thermal resistance RFTE is a resulting thermal resistance of a convection heat transfer resistance RFTE1 and a radiation heat transfer resistance RFTE2, wherein the convection heat transfer resistance RFTE1 and the radiation heat transfer resistance RFTE2 are applied from the terminal portion to the external air. The thermal resistances RFCE and RFTE are calculated as follows:

$$\{ \begin{matrix}\frac{1}{RFCE} = \frac{1}{RFCE 1} + \frac{1}{RFCE 2} \\ \frac{1}{RFTE} = \frac{1}{RFTE 1} + \frac{1}{RFTE 2}\end{matrix} \qquad ( 15 )$$

The convection heat transfer resistances RFCE1 and RFTE1 as well as the radiation heat transfer resistances RFCE2 and RFTE2 are calculated by means of thermofluid analysis.

In FIG. 15, a thermal resistance RFCC is a thermal resistance in heat transfer from the fuse case to the circuit case CC through the internal air (air inside the circuit case CC), and a thermal resistance RFTC is a thermal resistance in heat transfer from the terminal portion to the circuit case CC through the internal air. The thermal resistance RFCC is a resulting thermal resistance of a convection heat transfer resistance RFCC1 and a radiation heat transfer resistance RFCC2, wherein the convection heat transfer resistance RFCC1 is applied from the fuse case to the circuit case CC through the internal air, and the radiation heat transfer resistance RFCC2 is applied from the fuse case to the case through the internal air. The thermal resistance RFTC is a resulting thermal resistance of a convection heat transfer resistance RFTC1 and a radiation heat transfer resistance RFTC2, wherein the convection heat transfer resistance RFTC1 and the radiation heat transfer resistance RFTC2 are applied from the terminal portion to the circuit case CC through the internal air. The thermal resistances RFCC and RFTC are calculated as follows:

$$\{ \begin{matrix}\frac{1}{RFCC} = \frac{1}{RFCC 1} + \frac{1}{RFCC 2} \\ \frac{1}{RFTC} = \frac{1}{RFTC 1} + \frac{1}{RFTC 2}\end{matrix} \qquad ( 16 )$$

The convection heat transfer resistances RFCC1 and RFTC1 as well as the radiation heat transfer resistances RFCC2 and RFTC2 are calculated by means of thermofluid analysis.

In FIGS. 14 and 15, the terminals TF1 and TF2 of the device DF are terminals to be connected to devices modelling other elements of the series circuit SC. In FIGS. 14 and 15, the terminal TF3 of the device DF is a terminal to be connected to the voltage source VSE modelling the thermal equivalent circuit for the external air or to the device DCC modelling the thermal equivalent circuit for the circuit case CC.

For the nodes of the thermal equivalent circuits for the fuse, a relation between a temperature of each of the nodes and a temperature of a node of the nodes adjacent to the node may be determined according to the Kirchhoff's law similarly.

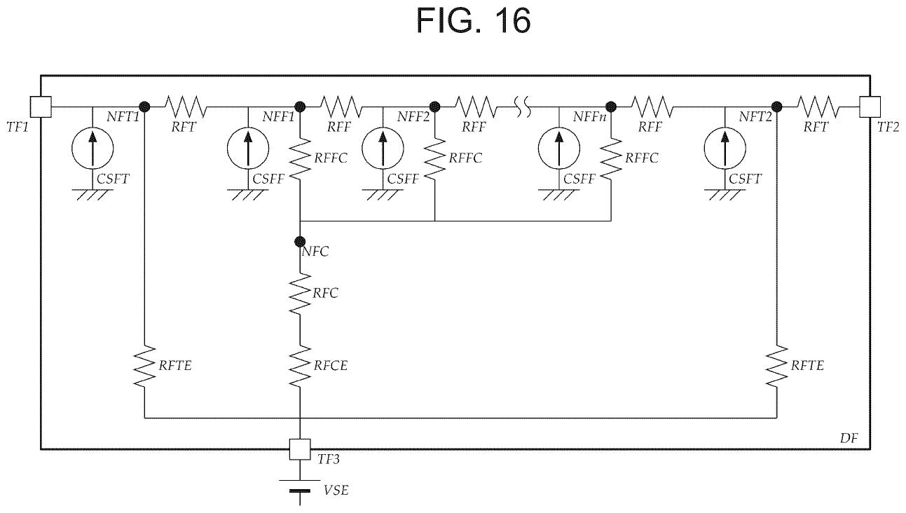

While the melted portion in FIGS. 14 and 15 is expressed as one node, the melted portion may be divided into a plurality of portions like the busbar or electric wire, wherein the portions may be indicated as a plurality of nodes NFF1, NFF2, . . . , NFFn, as shown in FIG. 16. FIG. 16 shows a thermal equivalent circuit of the fuse which is not accommodated in a circuit case CC. In this case, the thermal resistance RFF is a thermal resistance in heat transfer of each of the divided portions of the melted portion in the longitudinal direction. LFF is a length of each of the divided portions of the melted portion in the longitudinal direction. The thermal resistance RFFC is a thermal resistance in heat transfer from each of the divided portions of the melted portion to the fuse case. The current source CSFF models a Joule heat generated in each of the divided portions of the melted portion.

### (Modelling Process of a Thermal Equivalent Circuit for the Contactor)

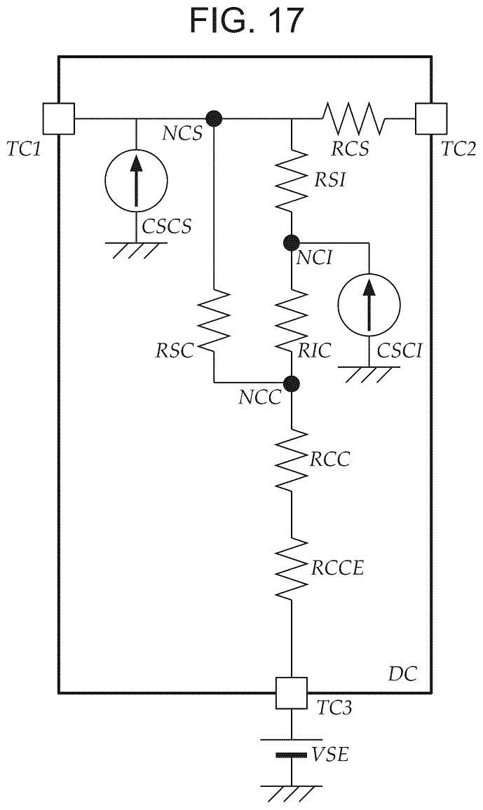

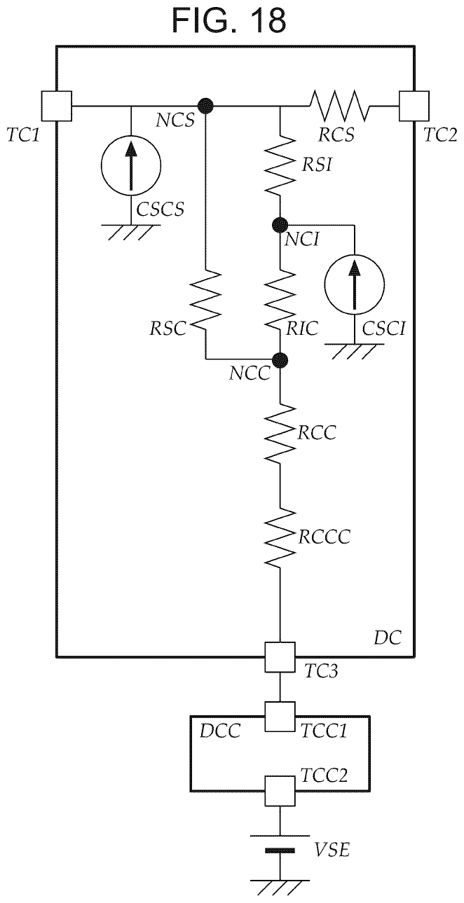

In a case where the series circuit SC includes a contactor as an electronic component, the first modelling section 112 models a thermal equivalent circuit for the contactor as a device DCC that includes one or more terminals to be connected to one or more thermal equivalent circuits for one or more other of the elements of the series circuit SC. FIGS. 17 and 18 show exemplary thermal equivalent circuits of a contactor modelled by the first modelling section 112. FIG. 17 shows a thermal equivalent circuit of the contactor which is not accommodated in a circuit case CC, while FIG. 18 shows a thermal equivalent circuit of the contactor which is accommodated in a circuit case CC.

The contactor as shown in FIGS. 17 and 18 includes a contact, a coil, and a case (contactor case) covering the contact and the coil. In FIGS. 14 and 15, a node NCS corresponds to the contact, a node NCI corresponds to the coil, and a node NCC corresponds to the contactor case.

In FIGS. 17 and 18, a current source CSCS models a Joule heat generated in the contact, and a current source CSCI models a Joule heat generated in the coil.

In FIGS. 17 and 18, a thermal resistance RCS is a thermal resistance in heat transfer of the contact in a longitudinal direction (direction in which the contact extends). The thermal resistance RCS is calculated according to the following formula:

$$RCS = \frac{LCS}{λ CS \cdot SCS} , \qquad ( 17 )$$

wherein LCS indicates a length of the contact in the longitudinal direction, XCS indicates a thermal conductivity of the contact, SCS indicates a cross-section area of the contact along a plane perpendicular to the longitudinal direction. While the node NCS in FIGS. 17 and 18 corresponds to an end of the contact, the node NCS may correspond to a middle portion of the contact in the longitudinal direction. In this case, the thermal resistance in the heat transfer of the contact in the longitudinal direction is positioned on each of opposite sides of the node NCS with a thermal resistance value of RCS/2.

In FIGS. 17 and 18, a thermal resistance RSI is a thermal resistance in heat transfer from the contact to the coil, and a thermal resistance RSC is a thermal resistance in heat transfer from the contact to the contactor case. A thermal resistance RIC is a thermal resistance in heat transfer from the coil to the contactor case. The thermal resistances RSI, RSC and RIC are calculated by means of thermofluid analysis.

In FIGS. 17 and 18, a thermal resistance RCC is a thermal resistance in heat transfer from the inside to the outside of the contactor case. For example, the thermal resistance RCC is calculated according to the following formula:

$$RCC = \frac{LCC}{λ CC \cdot SCC} , \qquad ( 18 )$$

wherein LCC indicates a length of the contactor case in a longitudinal direction, XCC indicates a thermal conductivity of the contactor case, SCC indicates a cross-section area of the contactor case along a plane perpendicular to the longitudinal direction.

In FIG. 17, a thermal resistance RCCE is a thermal resistance in heat transfer from the contactor case to the external air (air outside the contactor). The thermal resistance RCCE is aresulting thermal resistance of a convection heat transfer resistance RCCE1 and a radiation heat transfer resistance RCCE2, wherein the convection heat transfer resistance RCCE1 and the radiation heat transfer resistance RCCE2 are applied from the contactor case to the external air. The thermal resistance RCCE is calculated as follows:

$$\frac{1}{RCCE} = \frac{1}{RCCE 1} + \frac{1}{RCCE 2} \qquad ( 19 )$$

The convection heat transfer resistance RCCE1 and the radiation heat transfer resistance RCCE2 is calculated by means of thermofluid analysis.

In FIG. 18, a thermal resistance RCCC is a thermal resistance in heat transfer from the contactor case to the circuit case CC through the internal air (air inside the circuit case CC). The thermal resistance RCCC is a resulting thermal resistance of a convection heat transfer resistance RCCC1 and a radiation heat transfer resistance RCCC2, wherein the convection heat transfer resistance RCCC1 is applied from the contactor case to the circuit case CC through the internal air, and the radiation heat transfer resistance RCCC2 is applied from the contactor case to the case through the internal air. The thermal resistance RCCC is calculated as follows:

$$\frac{1}{RCCC} = \frac{1}{RCCC 1} + \frac{1}{RCCC 2} \qquad ( 20 )$$

The convection heat transfer resistance RCCC1 and the radiation heat transfer resistance RCCC2 are calculated by means of thermofluid analysis.

In FIGS. 17 and 18, the terminals TC1 and TC2 of the device DCC are terminals to be connected to devices modelling other elements of the series circuit SC. In FIGS. 17 and 18, the terminal TC3 of the device DCC is a terminal to be connected to the voltage source VSE modelling the thermal equivalent circuit for the external air or to the device DCC modelling the thermal equivalent circuit for the circuit case CC.

For the nodes of the thermal equivalent circuits for the contactor, a relation between a temperature of each of the nodes and a temperature of a node of the nodes adjacent to the node may be determined according to the Kirchhoff's law similarly.

### <Second Modelling Section 113>

The second modelling section 113 is configured to perform connection of the thermal equivalent circuits modelled by the first modelling section 112 in order to model a thermal equivalent circuit for the series circuit SC, wherein the connection is performed through the terminals. FIG. 19 shows an example of a thermal equivalent circuit of a series circuit SC which is configured as the exemplary series circuit SC as shown in FIG. 2. In FIG. 19, devices DW1 and DW2 model the electric wires W1 and W2 respectively. Devices DB1, DB2 and DB3 model the busbars B1, B2 and B3 respectively. Devices DF and DCC model the fuse F and contactor C respectively.

A relation between a temperature of each node and a temperature of a node adjacent to the node of the thermal equivalent circuit for the series circuit SC modelled by the second modelling section 113 may be determined according to the Kirchhoff's law. This means that the relation between the temperature of each node and the temperature of the adjacent node may be determined by using Kirchhoff's law, provided that values for thermal resistances included in the thermal equivalent circuit of the series circuit SC, a value for a heat flow provided by a current source, and a value for a temperature of a voltage source are known. Therefore, the information acquiring section 111 may be preferably configured to acquire values for thermal resistances included in the thermal equivalent circuits for the elements, a value for the heat flow provided by the current source, and the temperature value of the voltage source as parameters of the individual elements of the series circuit SC. Furthermore, the values for the thermal resistances included in the thermal equivalent circuits for the elements and/or the value for the heat flow provided by the current source may be calculated by means of one or more parameters such as a size (length and/or cross-section area) of each element, a value for a current flowing through each element, a resistance value of each element, and/or a thermal conductivity of each element. Therefore, the information acquiring section 111 may be configured to acquire, as the parameters of the individual elements of the series circuit SC, one or more parameters used for calculating the values for the thermal resistances included in the thermal equivalent circuits for the elements and/or the value for the heat flow provided by the current source (for example a size (e.g. length and/or cross-section area) of each element, a value for a current flowing through each element, a resistance value of each element, and/or a thermal conductivity of each element).

The present embodiment has been described above with reference to the thermal equivalent circuits in the stationary state. The temperature distribution calculating section 114 may calculate a temperature distribution in a non-stationary state by taking heat capacities of the individual nodes into account (more specifically, a heat capacity of a busbar portion with the first length, a heat capacity of individual elements of an electric wire portion with the second length, a heat capacity of each of the fuse and contactor, and a heat capacity of the circuit case). For calculating the temperature distribution in the non-stationary state, the relation between the temperature of each node and the temperature of the adjacent node of the thermal equivalent circuit for the busbar may be determined according to the Kirchhoff's law by taking the heat capacities of the individual nodes into account. For calculating the temperature distribution in the non-stationary state, the information acquiring section 111 may be therefore preferably configured to further acquire initial temperatures of the individual nodes of the elements of the series circuit SC (more specifically, an initial temperature of a busbar portion with the first length, an initial temperature of individual elements of an electric wire portion with the second length, an initial temperature of each of the fuse and contactor, and an initial temperature of the circuit case), and heat capacities of the individual nodes of the elements of the series circuit SC.

### <Cooling Process of Elements of the Series Circuit SC>

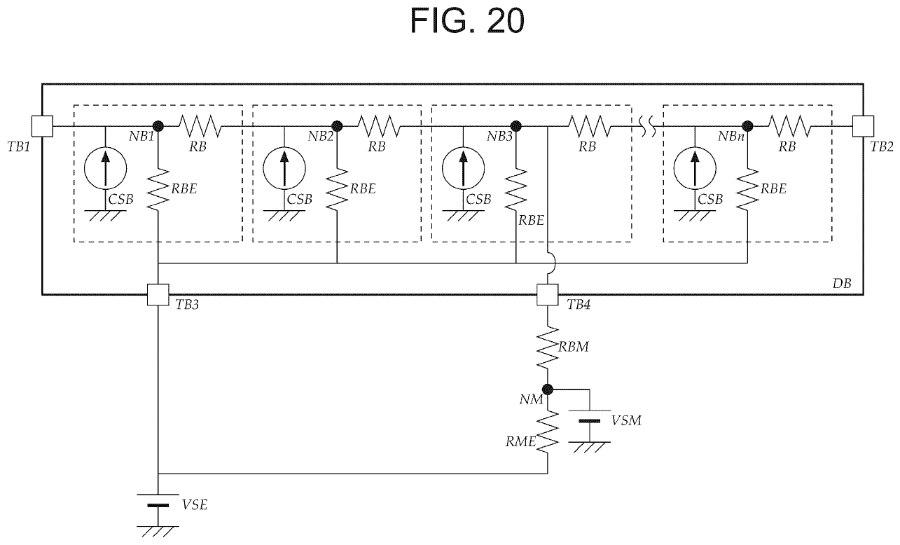

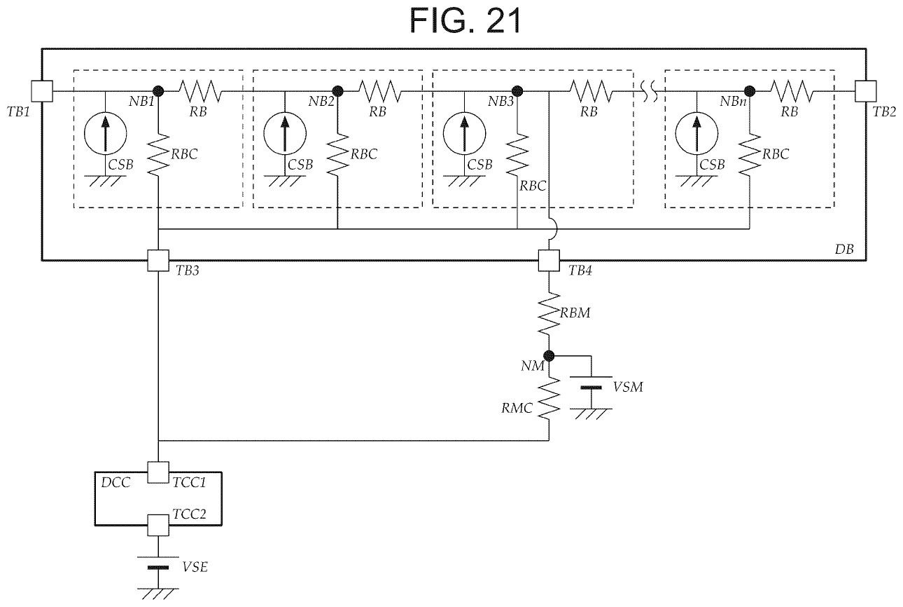

The elements of the series circuit SC may be configured to be cooled by a cooling unit (e.g. water-cooling unit). In a case where the series circuit SC includes one or more busbars, at least part of the one or more busbars may be preferably cooled by the cooling unit. FIGS. 20 and 21 show exemplary thermal equivalent circuits of busbars modelled by the first modelling section 112. FIG. 20 shows a thermal equivalent circuit of busbars which are not accommodated in a circuit case CC, while FIG. 21 shows a thermal equivalent circuit of busbars which are accommodated in a circuit case CC.

In FIGS. 20 and 21, a portion of the busbar corresponding to the node NB3 is cooled by the cooling unit while portions of the busbar corresponding to node NB1, NB2, NBn are not cooled by the cooling unit.

In FIGS. 20 and 21, a node NM corresponds to the cooling unit.

In FIGS. 20 and 21, a voltage source VSM models a temperature of the cooling unit, and a thermal resistance RBM is a thermal resistance in heat transfer from the busbar to the cooling unit. The thermal resistance RBM is calculated by means of thermofluid analysis.

In FIG. 20, a thermal resistance RME is a thermal resistance in heat transfer from the cooling unit to the external air (air outside the cooling unit). The thermal resistance RME is a resulting thermal resistance of a convection heat transfer resistance RME1 and aradiation heat transfer resistance RME2, wherein the convection heat transfer resistance RME1 and the radiation heat transfer resistance RME2 are applied from the cooling unit to the external air. The thermal resistance RME, i.e. the resulting thermal resistance, is calculated from the convection heat transfer resistance RME1 and radiation heat transfer resistance RME2 as follows:

$$\frac{1}{RME} = \frac{1}{RME 1} + \frac{1}{RME 2} \qquad ( 21 )$$

The convection heat transfer resistance RME1 and the radiation heat transfer resistance RME2 are calculated by means of thermofluid analysis.

In FIG. 21, a thermal resistance RMC is a thermal resistance in heat transfer from the cooling unit to the circuit case CC through internal air (air inside the circuit case CC). The thermal resistance RMC is a resulting thermal resistance of a convection heat transfer resistance RMC1 and a radiation heat transfer resistance RMC2, wherein the convection heat transfer resistance RMC1 and the radiation heat transfer resistance RMC2 are applied from the cooling unit to the circuit case CC through the internal air. The thermal resistance RMC, i.e. the resulting thermal resistance, is calculated from the convection heat transfer resistance RMC1 and radiation heat transfer resistance RMC2 as follows:

$$\frac{1}{RMC} = \frac{1}{RMC 1} + \frac{1}{RMC 2} \qquad ( 22 )$$

The convection heat transfer resistance RMC1 and the radiation heat transfer resistance RMC2 are calculated by means of thermofluid analysis.

In FIGS. 20 and 21, a terminal TB4 of the device DB is a terminal to be connected to the cooling unit via a thermal resistance RBM.

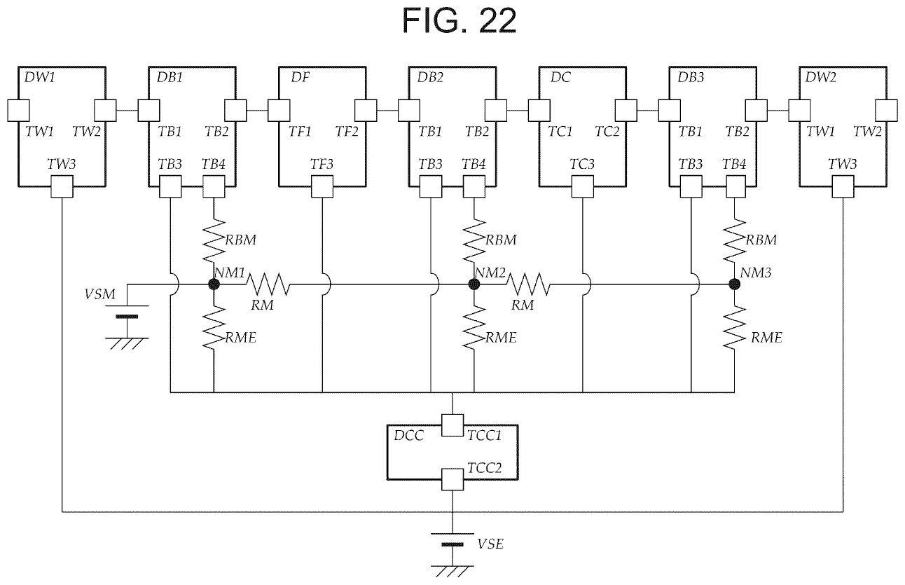

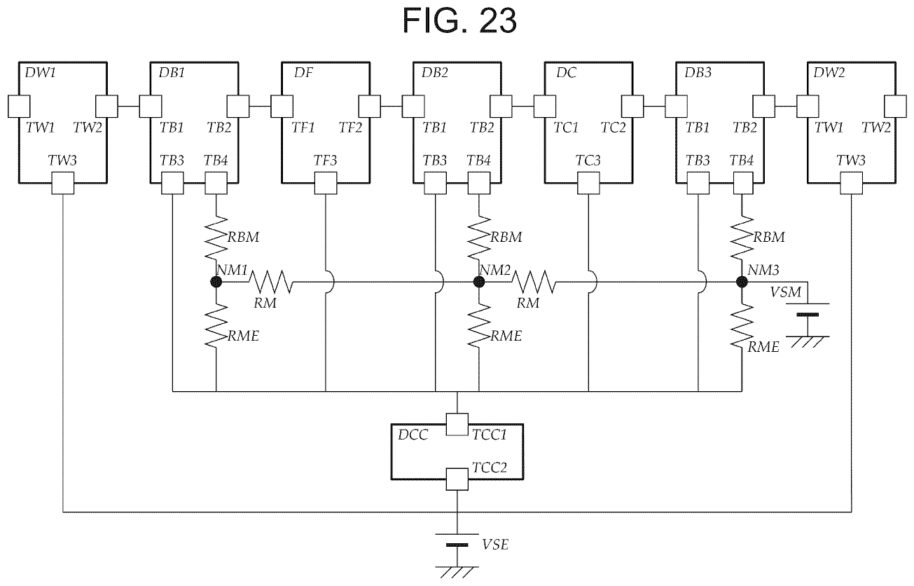

In a case where the series circuit SC includes a plurality of busbars, the plurality of busbars may be preferably cooled by a single cooling unit. In the example shown in FIG. 2, when part of each of the busbars B1, B2 and B3 is cooled by a single cooling unit, a thermal equivalent circuit for the series circuit SC is obtained as shown in FIGS. 22 and 23.

In FIGS. 22 and 23, a thermal resistance RM is a thermal resistance in heat transfer in a direction of flowing of a coolant of the cooling unit. The thermal resistance RM is calculated based on a flow rate and/or a thermal conductivity of the coolant of the cooling unit and/or a size of the cooling unit (for example, a size of a region through which the coolant flows).

In FIG. 22, the voltage source VSM is connected to the busbar B1, and therefore, the busbars B1, B2 and B3 are cooled in an order of busbars B1, B2 and B3. In FIG. 23, the voltage source VSM is connected to the busbar B3, and therefore, the busbars B1, B2 and B3 are cooled in an order of busbars B3, B2 and B1.

The information acquiring section 111 may be preferably configured to acquire an order of cooling in which the elements of the series circuit SC is cooled, wherein the second modelling section 113 may be configured to model the thermal equivalent circuit for the series circuit SC based on the order of cooling acquired by the information acquiring section 111. For example, in the example shown in FIG. 2, the information acquiring section 111 acquires an order of cooling in which the busbars B1, B2 and B3 are cooled, wherein the second modelling section 113 then models the thermal equivalent circuit for the series circuit SC as shown in FIG. 22. When the information acquiring section 111 acquires an order of cooling in which the busbars B3, B2 and B1 are cooled, the second modelling section 113 then models he thermal equivalent circuit for the series circuit SC as shown in FIG. 23.

The present invention has been described above with reference to a preferred embodiment of the present invention. While the present invention has been described above by illustrating specific examples, various modifications and alterations to the specific examples are possible without departing from the spirit and scope of the present invention as defined in the claims.

### REFERENCE SIGNS LIST

100 Analysis device
110 Control section
111 Information acquiring section
112 First modelling section
113 Second modelling section
114 Temperature distribution calculating section
115 Output processing section
120 Input section
130 Storage section
140 Output section

What is claimed is:

1. An information processing system for analyzing a temperature distribution of a series circuit including an electronic component, the information processing system comprising:
a first modelling section configured to model a thermal equivalent circuit for each of elements of a series circuit as a device that includes one or more terminals to be connected to one or more thermal equivalent circuits for one or more other of the elements of the series circuit; and
a second modelling section configured to perform connection of thermal equivalent circuits modelled by the first modelling section in order to model a thermal equivalent circuit for the series circuit,
wherein the connection is performed through the one or more terminals.

2. The information processing system according to claim 1,
wherein at least part of the series circuit is accommodated in a case,
wherein the first modelling section is configured to:
model the thermal equivalent circuit for each of the elements of the series circuit as a device that includes the one or more terminals to be connected to the one or more thermal equivalent circuits for the one or more other of the elements of the series circuit as well as a terminal to be connected to a thermal equivalent circuit for external air or a thermal equivalent circuit for the case; and
model the thermal equivalent circuit for the case as a device that includes a terminal to be connected to a thermal equivalent circuit for each of one or more of the elements of the series circuit accommodated in the case as well as a terminal to be connected to the thermal equivalent circuit for the external air.

3. The information processing system according to claim 1,
wherein the series circuit includes a busbar,
wherein the first modelling section is configured to:
divide the busbar into a plurality of busbar portions;
model basic thermal equivalent circuits for an electric wire, each of the basic thermal equivalent circuits corresponding to a thermal equivalent circuit for one of the busbar portions;
connect the basic thermal equivalent circuits for the busbar to model a thermal equivalent circuit for the busbar.

4. The information processing system according to claim 3,
wherein at least part of the busbar is configured to be cooled by a cooling unit.

5. The information processing system according to claim 4,
wherein the series circuit includes a plurality of busbars,
wherein the cooling unit is configured to cool the plurality of busbars, and
wherein the second modelling section is configured to model the thermal equivalent circuit for the series circuit based on an order for cooling the plurality of busbars by the cooling unit.

6. The information processing system according to claim 1,
wherein the series circuit includes an electric wire,
wherein the first modelling section is configured to:
divide the electric wire into a plurality of electric wire portions;
model basic thermal equivalent circuits for an electric wire, each of the basic thermal equivalent circuits corresponding to a thermal equivalent circuit for one of the electric wire portions;
connect the basic thermal equivalent circuits for the electric wire to model a thermal equivalent circuit for the electric wire.

7. The information processing system according to claim 1,
wherein the electronic component includes a fuse.

8. The information processing system according to claim 1,
wherein the electronic component includes a contactor.

9. An information processing method implemented by a computer for analyzing a temperature distribution of a series circuit including an electronic component, the information processing method comprising:
a first modelling step of modelling a thermal equivalent circuit for each of elements of a series circuit as a device that includes one or more terminals to be connected to one or more thermal equivalent circuits for one or more other of the elements of the series circuit; and
a second modelling step of performing connection of thermal equivalent circuits modelled according to the first modelling step in order to model a thermal equivalent circuit for the series circuit,
wherein the connection is performed via the one or more terminals.

10. An information processing program configured to cause a computer to perform the information processing method according to claim 9.
